(19) United States
(12) Patent Application Publication
(10) Pub. No.: US 2014/0325082 A1
(43) Pub. Date: Oct. 30, 2014

(54) NETWORK APPLICATION DEVICE, NETWORK CONNECTION METHOD, AND NETWORK CONNECTION SYSTEM

(71) Applicant: ICATCH INC., Taipei (TW)

(72) Inventors: Ren-Hao Hsu, Taipei (TW); Chia-Mao Huang, Taipei (TW)

(73) Assignee: ICATCH INC., Taipei (TW)

(21) Appl. No.: 14/261,123

(22) Filed: Apr. 24, 2014

Related U.S. Application Data
(60) Provisional application No. 61/815,572, filed on Apr. 24, 2013.

(51) Int. Cl. H04L 29/08

(52) U.S. Cl. CPC H04L 67/14
USPC 709/228

(57) ABSTRACT

Disclosed herein is a network application device (NAD), comprising a connection assistant module and an application module. The connection assistant module connects to a traversal server, causing the traversal server to receive a physical network address of the NAD. The application module connects to the connection assistant module at a local port number. Also disclosed herein is a network connection system, comprising said traversal server and a first and a second said NAD. The traversal server receives a unique identifier associated with the second NAD when the connection assistant module of the first NAD connects to the traversal server, and provides the same connection assistant module with a physical network address of the second NAD. The application module of the first NAD thereby communicates with the second NAD through the connection assistant module.

### CROSS-REFERENCE TO RELATED APPLICATIONS

This application claims priority based on U.S. Provisional Application, Ser. No. 61/815,572, filed Apr. 24, 2013, entitled INTERNET CONNECTION SYSTEM, which is hereby incorporated by reference in its entirety.

### TECHNICAL FIELD

The present invention relates to network connectivity, particularly to wrapping a network application in a communication protocol layer that facilitates network address translation (NAT) traversal.

### BACKGROUND

Although NAT somewhat solves the problems of insufficient address space and unfair issuance in Internet Protocol version 4 (IPv4), essentially it sacrifices user convenience and freedom and over-complicates network applications attempting its traversal. In particular, NAT severely limits the possibility of a casual user to set up a server. Even if the user chooses a piece of application software capable of NAT traversal, such functionality is often too deeply buried in the application to be recycled and shared, in violation with the abstraction and object-orientation principles in the software development and usage cycle.

### SUMMARY

The present invention aims to separate NAT traversal from the network application itself. To that end, the present invention discloses a network application device, a corresponding network connection method, and a network connection system comprising the said network application device.

The network application device provided by this disclosure comprises a connection assistant module and an application module. The connection assistant module has a local port number and is configured to connect to a traversal server, causing the latter to receive a first physical network address of the network application device. The application module is configured to connect to the connection assistant module at the local port number.

The network connection method provided by this disclosure comprises connecting to a connection assistant module at a local port number and connecting to a traversal server. The connection to the traversal server causes it to receive a first physical network address.

The network connection system provided by this disclosure comprises a traversal server and two network application devices, a first one and a second one. The first network application device comprises a first application module and a first connection assistant module. The first connection assistant module has a first local port number and is configured to connect to the traversal server. The first application module is configured to connect to the first connection assistant module at the first local port. The second network application device comprises a second application module and a second connection assistant module. The second connection assistant module has a second local port number and is configured to connect to the traversal server. The second application module is configured to connect to the second connection assistant module at the second local port. The traversal server is configured to receive a second physical network address of the second network application device when the second connection assistant module connects to the traversal server, to receive a unique identifier associated with the second network application device when the first connection assistant module connects to the traversal server, and to provide the first connection assistant module with the second physical network address based on the unique identifier.

### BRIEF DESCRIPTION OF THE DRAWING

The present invention will become more fully understood from the detailed description given hereinbelow and the accompanying drawings which are given by way of illustration only and thus are not limitative of the present invention and wherein:

FIG. 1 is a block diagram of a network connection system comprising network application devices, in accordance with an embodiment of the present invention.

FIG. 2A is a flowchart of a network connection method, in accordance with an embodiment of the present invention.

FIG. 2B is a flowchart associated with the second network application device of a network connection system, in accordance with an embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

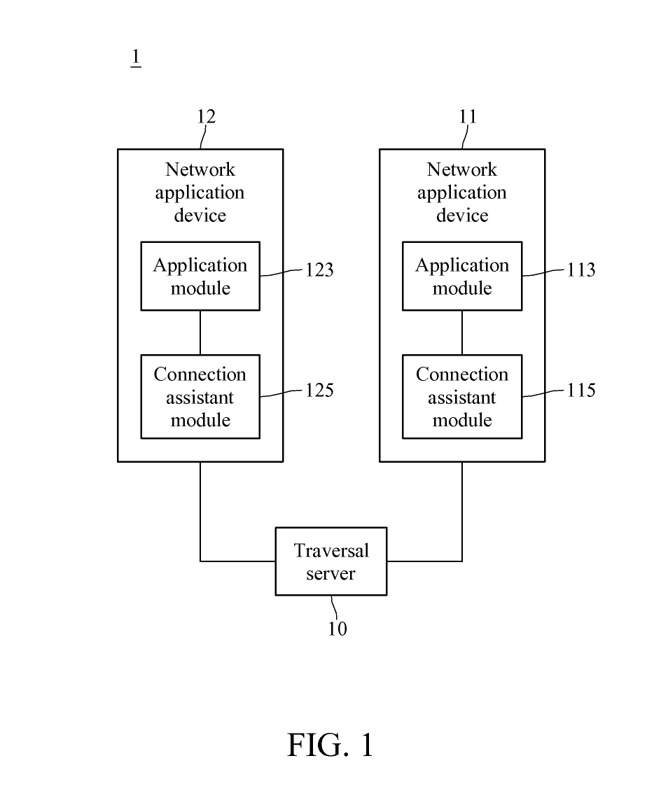

Please refer to FIG. 1. As shown in the block diagram, a network connection system 1 comprises a traversal server 10 and network application devices 11 and 12 (hereinafter referred to as NADs). The traversal server 10 does not have to be universally accessible on the Internet, but it is at least visible to and able to accept connections from the NADs 11 and 12, as signified by its coupling in FIG. 1. The NADs 11 and 12 are respectively different embodiments of the NAD of the present invention. In the network connection system 1, the NADs 11 and 12 are subject to the client-server model. For instance, the NAD 12 may be a video-streaming digital video recorder (DVR) or IP camera, and the NAD 11 may be a tablet, a personal computer, or a mobile telephone configured to connect to the NAD 12 to receive that stream. In another embodiment of the network connection system of the present invention, the two NADs may be equals, e.g. as nodes in an overlay peer-to-peer network.

The application module and the connection assistant module of the NAD of the present invention may be different processes on one or more hosts or may be separate dedicated hardware equipment. The application module represents a general network application, whereas the connection assistant module assists the application module in communication with its counterpart. In one embodiment, the connection assistant module is a service or kernel module in an operating system, listening to packets from the application module at a local port number. Here ‘local’ refers to the host on which the connection assistant module resides. When the application module and connection assistant module are on the same host, the former can connect to the latter at, for example, ‘localhost:80’, where 80 is the local port number.

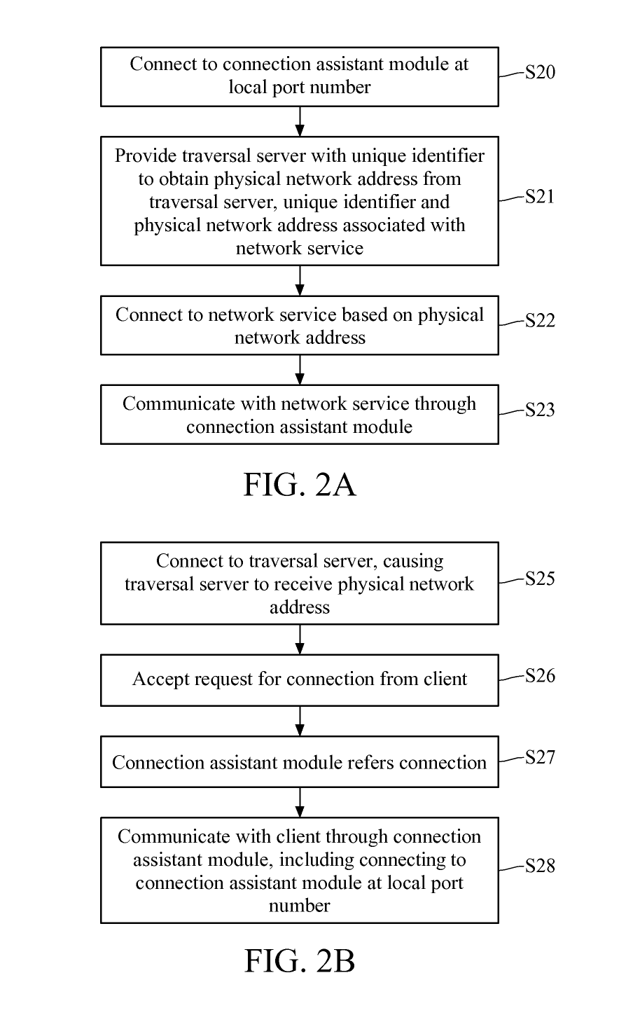

Specifically, the NAD 11, which comprises an application module 113 and a connection assistant module 115, operates as depicted in FIG. 2A. In step S20, the application module 113 connects to the connection assistant module 115 at the latter's local port number. In step S21, the connection assistant module 115 connects to the traversal server 10 to provide a unique identifier associated with some network service (i.e. that provided by the NAD 12). The unique identifier may be provided by the application module 113 in step S20; that is, step S21 is executed in response to step S20. Of course, the unique identifier may also be known to the connection assistant module 115 beforehand. The unique identifier is only for identification by the NAD 11 and the traversal server 10; the network service (or the NAD 12) might not be aware of it. In one embodiment, the unique identifier is input by a user of the NAD 11, manually through a user interface for instance. In another example, assuming that the NAD 11 comprises a camera, the user can then operate that camera to scan a one- or two-dimensional barcode (e.g. Quick Response code) so that the NAD 11 obtains the unique identifier.

In response to the connection from the connection assistant module 115, the traversal server 10 naturally receives a physical network address of the NAD 11 and, based on the unique identifier, finds out and provides the connection assistant module 115 with a physical network address of the NAD 12. A network address may be a combination of an IP address and a port number, or may comprise a domain name. ‘Physical’ refers to the fact that this IP address is public or—to the NAD 12—at least accessible to the network service's intended audience. The IP address may be static or non-static. A non-static public IP address may be issued in association with a dynamic domain name service (DDNS).

In step S22, the connection assistance module 115 connects to the NAD 12 using the obtained physical network address. The NAD 12 comprises an application module 123 and a connection assistant module 125; specifically, therefore, the connection assistant module 115 is in connection with the connection assistant module 125 (without going via the traversal server 10). As a result, the application module 113, which is already connected to the connection assistant module 115, can communicate with the NAD 12 in step S23.

To illustrate the network connection method from the point of view of the NAD 12, please refer to FIG. 2B. As shown in this flowchart, in step S25, the connection assistant module 125 connects to the traversal server 10, causing the traversal server 10 to receive a physical network address of the NAD 12. (Hence the connection assistant module 115 is able to obtain it in step S21.) In one embodiment, the connection assistant module 125 further provides the traversal server 10 with a virtual network address of the NAD 12. As described before, a network address may be a combination of an IP address and a port number, or may comprise a domain name. When the NAD 12 is behind a router or firewall implementing NAT, ‘virtual’ signifies that this IP address is, for instance, a private IP address on a local area network, employed for an NAD to communicate with the said NAT equipment. In networking parlance, step S25 is the process by which the NAD 12 registers itself to the traversal server 10, and whereby the traversal server 10 associates the unique identifier of the NAD 12 with its physical network address. In step S26, the connection assistant module 125 receives a request for connection from a client (i.e. the NAD 11) and refers the established connection to the application module 123 in step S27. Step S26 occurs because of step S22, while steps S21 and S22 are in response to the attempt by the application module 113 to communicate with the application module 123. In particular, during step S27, the connection assistant module 125 connects to the application module 123 (similar to step S21, only in reverse) and forwards thereto contents of packets from the NAD 11. In one embodiment, the connection assistant module 125 connects to the application module 123 at the latter's local port number. In one embodiment, the local port number of the application module 123 is identical to that of the connection assistant module 115. For example, suppose that the application module 123 is a Secure Shell server having a local port number of 22. When the application module 113, as a client, connects to the connection assistant module 115 at ‘localhost:22’ and is referred to communicate with the application module 123, the application module 113 is prone to think that ‘localhost:22’ is the network address of the Secure Shell server. Such a feature of the network connection system is especially helpful to application software where port numbers are programmed as constants.

In step S28, to communicate with the application module 113 or acknowledge the referral of the connection assistant module 125, the application module 123 also connects to the connection assistant module 125 at the latter's local port number. The application modules 113 and 123 thereby communicate with each other through the connection assistant modules 115 and 125, respectively.

Please note that the network connection method as presented by FIGS. 2A and 2B is in practice part of a complete NAT-traversal procedure. For the more complicated types of NAT, such as address-restricted-cone, port-restricted-cone, or symmetric ones, the network connection method of the present invention can be employed in conjunction with the STUN (Session Traversal Utilities for NAT), TURN (Traversal Using Relays around NAT), or ICE (Interactive Connectivity Establishment) protocol.

To summarize, by wrapping network applications in a communication protocol layer that facilitates NAT traversal, a user operating a client need not be equipped with profession knowledge. Providing only a unique identifier, the client is able to obtain information required for connecting to the server from a traversal server. Under most networking circumstances, the network connection system of the present invention enables the NADs therein to successfully communicate with each other.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments of the invention. It is intended, therefore, that the specification and examples be considered as exemplary only, with a true scope and spirit of the invention being indicated by the following claims and their full scope of equivalents.

What is claimed is:

1. A network application device comprising:
a connection assistant module having a local port number and configured to connect to a traversal server, causing the traversal server to receive a first physical network address of the network application device; and
an application module configured to connect to the connection assistant module at the local port number.

2. The network application device of claim 1, wherein when the connection assistant module connects to the traversal server, the connection assistant module provides the traversal server with a unique identifier in order to obtain a second physical network address from the traversal server, the unique identifier and the second physical network address associated with a network service, and wherein the connection assistant module is further configured to connect to the network service based on the second physical network address, the application module communicating with the network service through the connection assistant module.

3. The network application device of claim 1, wherein the connection assistant module is further configured to accept a request for connection from a client, the application module communicating with the client through the connection assistant module.

4. The network application device of claim 1, wherein when the connection assistant module connects to the traversal server, the connection assistant module provides the traversal server with a virtual network address of the network application device.

5. A network connection system comprising:
a traversal server;
a first network application device comprising a first application module and a first connection assistant module, the first connection assistant module having a first local port number and configured to connect to the traversal server, the first application module configured to connect to the first connection assistant module at the first local port; and
a second network application device comprising a second application module and a second connection assistant module, the second connection assistant module having a second local port number and configured to connect to the traversal server, the second application module configured to connect to the second connection assistant module at the second local port;
wherein the traversal server is configured to receive a second physical network address of the second network application device when the second connection assistant module connects to the traversal server, to receive a unique identifier associated with the second network application device when the first connection assistant module connects to the traversal server, and to provide the first connection assistant module with the second physical network address based on the unique identifier.

6. The network connection system of claim 5, wherein the second application module has a third local port number identical to the first local port number.

7. A network connection method comprising:
connecting to a connection assistant module at a local port number; and
connecting to a traversal server, causing the traversal server to receive a first physical network address.

8. The network connection method of claim 7, wherein connecting to the traversal server comprises:
providing the traversal server with a unique identifier in order to obtain a second physical network address from the traversal server, the unique identifier and the second physical network address associated with a network service.

9. The network connection method of claim 8, further comprising:
connecting to the network service based on the second physical network address, in order to communicate with the network service through the connection assistant module.

10. The network connection method of claim 7, wherein connecting to the traversal server comprises providing the traversal server with a virtual network address.
